(19) United States
(12) Patent Application Publication
(10) Pub. No.: US 2021/0360853 A1
(43) Pub. Date: Nov. 25, 2021

(54) Autonomous System For Automating Garden Tasks And A Method For Automating Customizable Lawn Patterns

(71) Applicant: Jose Ricardo Herrera, Oakland, CA (US)

(72) Inventor: Jose Ricardo Herrera, Oakland, CA (US)

(21) Appl. No.: 17/327,755

(22) Filed: May 23, 2021

Related U.S. Application Data
(63) Continuation of application No. 63/028,569, filed on May 22, 2020.

(51) Int. Cl. A01D 43/14; A01D 34/00; A01D 43/16; A01D 42/00; A01D 34/64; A01D 34/74; A01D 34/78; A01G 25/09; A01G 25/16

(52) U.S. Cl. CPC A01D 43/14; A01D 34/008; A01D 43/16; A01D 42/00; A01D 2101/00; A01D 34/74; A01D 34/78; A01G 25/09; A01G 25/16; A01D 34/64

(57) ABSTRACT

A system and method for an autonomous robot to automate watering, mowing, fertilizing and several other gardening services. Consisting of a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein the robot body includes a navigation system arranged to assist a controller to control operation of the robot within predefined operating and target areas.

### CROSS-REFERENCE TO RELATED APPLICATIONS

This application is a continuation to U.S. patent application Ser. No. 63/028,569 May 22, 2020 but the 12-month period has passed for claiming the claims in provisional patent 63/028,569.

### TECHNICAL FIELD

The present invention relates to autonomous robots and a system for navigating and automating different lawn care services. Particularly, although not exclusively, to an autonomous robot which uses a navigating system to control robot navigation to perform lawn care services during operation.

### BACKGROUND

The maintenance of a healthy lawn and garden requires a significant amount of manual labor including constant watering, fertilizing and mowing of the lawn. The mowing process demands a significant amount of time and physical effort from gardeners. Watering or fertilizing require gardeners to either install a sprinkler or irrigation system or perform these tasks themselves. Automating these processes will allow gardeners to have more time for more desirable tasks.

Current designers and manufacturers of sprinkler or irrigation systems have attempted to automate the watering or fertilizing process of lawns or gardens. However, the unpredictability of how a landscape may change over time with the cost of having to adapt your systems for the changing landscape has meant many automated watering or fertilizing systems do not perform at an adequate level of performance and cost the gardener more time and effort. Designers and manufactures of autonomous lawn mowers have also attempted to automate the mowing process but due to unpredictable landscapes and the cost of creating an accurate and usable product has meant these systems do not perform as well as a traditional push mower. Also, these autonomous lawn mowers do not provide more than one lawn service causing the user to have to manually complete other lawn services like watering or fertilizing.

Due to gardens and lawns coming in different shapes, sizes and elevations, autonomous robots have had significant trouble navigating these terrains. Therefore, users still prefer watering, fertilizing, mowing themselves or spending money on gardening services.

### SUMMARY OF THE INVENTION

In accordance with a first aspect of the present invention, there is provided an autonomous robot/gardener consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns.

In an embodiment of the first aspect, the navigation system includes at least one navigation module, arranged to obtain necessary navigation data for navigating the robot.

In an embodiment of the first aspect, the navigation data is received and processed by the controller to control operation of the robot and create the mowing pattern requested by the user.

In an embodiment of the first aspect, the navigation data includes distance travelled, a surveyed representation of the operating and non-operating zones, location of target areas for the robot to focus operation on, directions and accelerations of the robot or any combination of one or more thereof.

In one example embodiment, the direction or heading of the robot can be obtained by using the controller to process magnetometer or Inertial measurement unit (IMU) data that is arranged to provide bearing data of the robot.

In an embodiment of the first aspect, one or more motor drivers are arranged to communicate with one or more motors to drive and steer the robot.

In an embodiment of the first aspect, the navigation system includes an optical surveying module arranged to survey and scan all proximate areas around the robot to create a surveyed representation of the operating and non-operating areas and detect obstacles.

In an embodiment of the first aspect, the term optical surveying module may include any surveying modules that are capable of assisting the robot to visualize its surroundings. Thus, “optical” may include surveying modules that use light based and non-light based technologies. Light based technologies may include, but not limited to, lasers and cameras for detecting objects. Non-light based technologies may include, but not limited to, radio waves (radar) or sonar (sound) waves. Therefore, the term “optical” includes technology that assists or enables the robot to visualize its surroundings.

In an embodiment of the first aspect, the optical surveying module is placed at an elevated position on the robot body.

In an embodiment of the first aspect, the optical surveying module is a LIDAR unit.

In one embodiment, there may be more than one LIDAR unit.

In an embodiment of the first aspect, the navigation system further includes a sonic or supersonic obstacle detection module arranged to use sound waves to detect any obstacles proximate to the robot.

In one embodiment, there may be a plurality of sonic or supersonic obstacle detection modules.

In an embodiment of the first aspect, the sonic obstacle detection module is a sonar unit.

In an embodiment, the sonic obstacle detection module is a laser sensor.

In an embodiment, the sonic obstacle detection module is an Infrared (IR) unit.

In an embodiment, the sonic obstacle detection module is a radio wave (RADAR) unit.

In an embodiment of the first aspect, the navigation module includes an Infrared (IR) module arranged to communicate with other optical or IR systems for obtaining navigation data of the robot.

This example embodiment is particularly advantageous when the robot must perform maneuvers in tight spaces and there is no room for error. For example, when the robot needs to go into its docking station, an IR system implemented on or adjacent to the docketing station can assist in navigating the robot into the docketing station as the IR can communicate the location of the robot relative to the docketing station.

In an embodiment of the first aspect, the navigation system includes an inertial measurement unit (IMU) arranged to measure physical forces invoked on the robot.

In an embodiment of the first aspect, the inertial measurement unit is removable from the robot so the user can perform the initialization process.

In an embodiment of the first aspect, the robot includes a magnetometer arranged to measure the bearing or heading of the robot to calculate the robot's direction in degrees.

In an embodiment of the first aspect, the user can remove the inertial measurement unit and operate the navigation of the robot by only using the magnetometer.

In an embodiment of the first aspect, the navigation system may also include a satellite navigation system, such as a Global Positioning System (GPS) or Real-Time Kinematics (RTK) system arranged to identify the position of the robot, the direction of travel and the ground speed of the robot.

In an embodiment of the first aspect, the navigation system further includes additional sensors arranged to provide navigation information, including GPS coordinates, infrared sensors, water/rain sensors, edge sensors, light sensors or any one or more combination thereof. Communication ports such as ports which may be arranged to communicate with WiFi, Bluetooth, Mobile telephony protocols, radio frequency, DECT, RFID or any other communication protocols may also be used to exchange navigation information, assist in the navigation process and provide real time data to the user either individually or in a combination with any sensor.

In an embodiment of the first aspect, the virtual representation of the operating area may be generated during operation or generated by the user in an initialization process.

In an embodiment of the first aspect, the initialization process consisting of calibrating sensors, setting one or more operating areas, and configuring the robot is performed by a user.

In an embodiment of the first aspect, the user may define an operation area by moving the robot around the perimeter of the one or more areas the user wants the robot to operate in.

In an embodiment of the first aspect, the user may define a target area that needs special attention by moving the robot unto that target area.

In an embodiment of the first aspect, the user may define one or more non-operating or exclusion areas by moving the robot around the perimeter of the one or more areas the user wants the robot to not navigate to.

In an embodiment of the first aspect, the user may define an operation area by using the provided software program and setting the operating areas using a mapping program.

In an embodiment of the first aspect, the user may define a target area that needs special attention by using the provided software program and setting the target areas using a mapping program.

In an embodiment of the first aspect, the user may define one or more non-operating or exclusion areas by using the provided software program and setting the exclusion areas using a mapping program.

In an embodiment of the first aspect, the non-operating areas defined by the user will signal to the robot controller where it is necessary to deactivate all operating mechanisms.

In an embodiment of the first aspect, the robot body includes designated areas for adding additional motors for a sprayer or trimmer. Including at least one tank for holding liquids used when spraying.

In an embodiment of the first aspect, the user can manually fill the tanks with their preferred liquid and signal to the robot where to spray by defining the target areas.

In an embodiment of the first aspect, the user can provide a customizable lawn pattern for the mowing operation of the robot. The controller will use this information to create a path plan for accomplishing the pattern. For example, a user can select a “traditional” pattern, where the term “traditional” means a cutting pattern where the robot goes end-to-end of the lawn in consecutive rows.

In an embodiment of the first aspect, the user can provide a customizable lawn pattern for the mowing operation through the robot user interface or the provided software program.

In an embodiment of the first aspect, the user can select from a catalog of provided lawn patterns or lawn patterns created by other users through the robot user interface or the provided software program.

In accordance with a second embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; and a battery module arranged to provide power supply to the motor; wherein the battery module is placed at a lower position within the robot body.

In an embodiment of the second aspect, the robot body further provides a battery cover arranged to cover the access to the battery module.

In accordance with a third embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body further includes a height adjustment system arranged to assist the controller to control the operation of the cutting blade or blades within a predefined operating height.

In an embodiment of the third aspect, the height adjustment system includes one or more sensors arranged to determine the height of the cutting blade.

In an embodiment of the third aspect, the height adjustment system is arranged to communicate with the one or more sensors and modules to determine the number of rotations required by the cutting blade or blades to reach the predefined operating height.

In an embodiment of the third aspect, the height adjustment system is arranged to communicate with the navigation modules and controller to determine the height requirements for each area inside the operating area or areas.

This example embodiment is particularly advantageous when the robot must create custom mowing patterns that are more complex and require different heights for different areas of the lawn.

In accordance with a fourth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the cutting blade or blades are pivotally connected to and driven by a motor-driven disc.

In an embodiment of the fourth aspect, the cutting blade or blades are arranged to rotate counterclockwise and clockwise.

In an embodiment of the fourth aspect, the cutting blade's motor or motors are connected to a motor-driven mechanism for controlling the blade's angle.

This example embodiment is particularly advantageous when the robot must create custom mowing patterns that are more complex and require different cutting angles on the lawn.

In accordance with a fifth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns;

wherein the robot body includes a trimmer or edging cutting module to trim edges of predefined areas.

In an embodiment of the fifth aspect, the cutter module is placed at a position underneath the robot body and adjacent to the operating circumference of the cutting blade.

In an embodiment of the fifth aspect, the cutter module is removably engaged with the robot body through a locking mechanism.

In accordance with a sixth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body includes at least one sprayer for watering or fertilizing in predefined target areas.

In an embodiment of the sixth aspect, the spraying module is placed at a position underneath the robot body and adjacent to the operating circumference of the cutting blade.

In an embodiment of the sixth aspect, the spraying module is removably engaged with the robot body through a locking mechanism.

In an embodiment of the sixth aspect, the spraying module tank or tanks are placed within the robot body.

In accordance with a seventh embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body includes at least one sprayer for watering or fertilizing and at least one trimmer for edging in predefined target areas.

In an embodiment of the seventh aspect, the spraying module and trimming module are placed at a position underneath the robot body and adjacent to the operating circumference of the cutting blade or blades.

In an embodiment of the seventh aspect, the spraying module and trimming module are removably engaged with the robot body through a locking mechanism.

In accordance with an eighth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body includes one or more rollers for changing angles of grass blades.

In an embodiment of the eighth aspect, the roller or rollers are substantially perpendicular to the operating direction of the robot.

In accordance with a ninth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; a battery module arranged to provide power supply to the motor and all robot components; and a detachable docking module arranged to provide battery charging to the battery module.

In an embodiment of the ninth aspect, the navigation system is further arranged to locate the robot with reference to the detachable docking module.

In an embodiment of the ninth aspect, the navigation system directs the robot towards the detachable docking module.

In an embodiment of the ninth aspect, the navigation system is used to provide an indication of the position of the detachable docking module relative to the robot.

In an embodiment of the ninth aspect, the navigation system may include an imaging module for obtaining the information associated with the position of the detachable docking module.

In an embodiment of the ninth aspect, the detachable docking module may provide the imaging module as an indication of the position of the detachable docking module.

In an embodiment of the ninth aspect, the indication may be represented in a graphical representation.

In an embodiment of the ninth aspect, the navigation system may include an Infrared (IR) module for providing an indication of the position of the detachable docking module.

In an embodiment of the ninth aspect, the navigation system may include a magnetometer for providing an indication of the position of the detachable docking module.

In an embodiment of the ninth aspect, the navigation system may include an optical surveying module for obtaining the information associated with the position of the detachable docking module.

In an embodiment of the ninth aspect, the optical surveying module is arranged to scan and survey the proximate area around the robot to devise the surveyed representation of the predefined operation area, thereby locating the position of the detachable docking module.

In an embodiment of the ninth aspect, the navigation system may include an induction wire system for obtaining the information associated with the position of the detachable docking module.

In an embodiment of the ninth aspect, the induction wire system includes at least one sensor arranged to communicate with a coil of the detachable docking module in an electromagnetic communication.

In accordance with a tenth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the navigation system includes a rotatable optical surveying module arranged to scan and survey the proximate area around the robot to devise the surveyed representation of the predefined operating area and devise a health report on the lawn or garden.

In an embodiment of the tenth aspect, the optical surveying module is further arranged to use an optical means to scan and survey the approximate area around the robot.

In an embodiment of the tenth aspect, the optical surveying module is placed at an elevated position on the robot body or under the robot body.

In an embodiment of the tenth aspect, the optical surveying module is a LIDAR unit. This example embodiment is particularly advantageous when the robot must create a health report on different target areas of the operating areas using the LIDAR unit.

In accordance with a eleventh embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the navigation system further includes a sonic obstacle detection module arranged to use sound waves to detect any obstacles proximate to the robot, the sonic obstacle detection module is disposed at an elevated position on the robot body for detecting the obstacles adjacent to the robot body.

In an embodiment of the eleventh aspect, the sonic obstacle detection module is a sonar unit.

In accordance with a twelfth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the autonomous system for automating garden tasks includes a software process and mobile application for initializing, configuring, scheduling operations, defining operation and target areas, checking health reports and sensor statuses.

In an embodiment of the twelfth aspect, the software process includes calibration instructions for sensors.

In an embodiment of the twelfth aspect, the software process includes on demand sensor status reports.

In an embodiment of the twelfth aspect, the software process includes configurable options including, but not limited to, setting or changing the operation schedule, defining and modifying the areas to operate and not to operate in, downloading and creating new mowing patterns, starting or stopping the robot, and check health reports.

In accordance with a thirteenth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body further includes a sensor arranged to assist the controller to terminate the movement of the robot body upon the robot fully entering the detachable docking module.

In an embodiment of the thirteenth aspect, the detachable docking module includes a magnetic member arranged to communicate with the controller through the sensor.

In an embodiment of the thirteenth aspect, the robot body includes an opening within which the sensor is positioned.

In an embodiment of the thirteenth aspect, the magnetic member is inserted into the opening upon the robot entering the detachable docking module completely.

In accordance with a fourteenth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body further includes a cooling unit and seals that protect the robot's components within its body from moisture.

In an embodiment of the fourteenth aspect, the cooling unit is one or more fans positioned to cool the controller and other components within the robot body.

In accordance with a fifthteenth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; a detachable docking module arranged to provide battery charging to the robot body; wherein the detachable docking module further includes a rotatable member arranged to contact the robot body for battery charging.

In an embodiment of the fifteenth aspect, the rotatable member may extend laterally from the detachable docking module after being arranged to a predefined vertical offset.

In an embodiment of the fifteenth aspect, the robot includes an opening for receiving the rotatable member.

In an embodiment of the fifteenth aspect, the rotatable member may lay parallel to the ground and contact the robot through the robot's ground contact points, for example, the robot's wheels are a contact point to the ground.

In an embodiment of the fifteenth aspect, the detachable docking module is provided with a pair of resilient means for acting against the opposite sides of the rotatable member to maintain the orientation of the rotatable member and prevent short-circuits.

In an embodiment of the fifteenth aspect, the rotatable member is provided with a protective gasket for reducing the impact between the rotatable member and the robot body.

In accordance with a sixteenth embodiment of the present invention, there is provided an autonomous robot consisting: a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body further includes a hinge system to move a cover between close and open positions for covering and exposing an user interface area without hindering an exposed portion of the other robot's modules.

In embodiment of the sixteenth aspect, the user interface is arranged to configure the robot, start or stop operation, set operation schedules and mowing patterns.

### BRIEF DESCRIPTION OF THE DRAWINGS

Embodiments of the present invention will now be described, by way of example, with references to the accompanying drawings in which:

FIG. 1 is an illustration of an autonomous robot in accordance with one embodiment of the present invention, including illustrations of the spraying mechanism and the motor-driven disk for the cutting blade;

FIG. 2 are illustrations of the outer shell of the autonomous robot of FIG. 1 including the hinge cover for the exposed components, user interface, moisture sensors, switches, ports, charging contact discs, and the caster wheels.;

FIG. 3 are more illustrations of the outer shell of the autonomous robot of FIG. 1 including the sonar sensors used for obstacle detection, the detachable docking module with rotatable metal charging points, an air vent for cooling the robot, and a bumper sensor system for detecting robot collisions;

FIG. 4 are illustrations of a trailer that can be used for seeding a lawn or garden. The robot's hinge system for connecting the trailer to the robot is also illustrated;

FIG. 5 includes two block diagrams for illustrating an example of various control systems and modules for the autonomous robot of FIG. 1 and the detachable docking module. The autonomous robot's control systems and modules are illustrated by reference numbers 500-514. The detachable docking module's control systems and modules are illustrated by reference numbers 600-603;

FIG. 6 illustrates examples of the software program and mobile application that is used to configure and set up the robot, pick mowing pattern and check health reports;

FIG. 7 illustrates examples of the software program and mobile application that is used to set the operational and non-operational boundaries, setting the target areas and customizing the mowing pattern;

FIG. 8 illustrates a diagram for the process that is used by the robot to automate different gardening tasks like mowing, watering and fertilizing;

FIG. 9 illustrates examples of different mowing patterns for cutting the lawn in customizable ways. Shown patterns include, but are not limited to, a traditional pattern, a diamond pattern and a random pattern.

### DETAILED DESCRIPTION OF THE PREFERRED EMBODIMENT

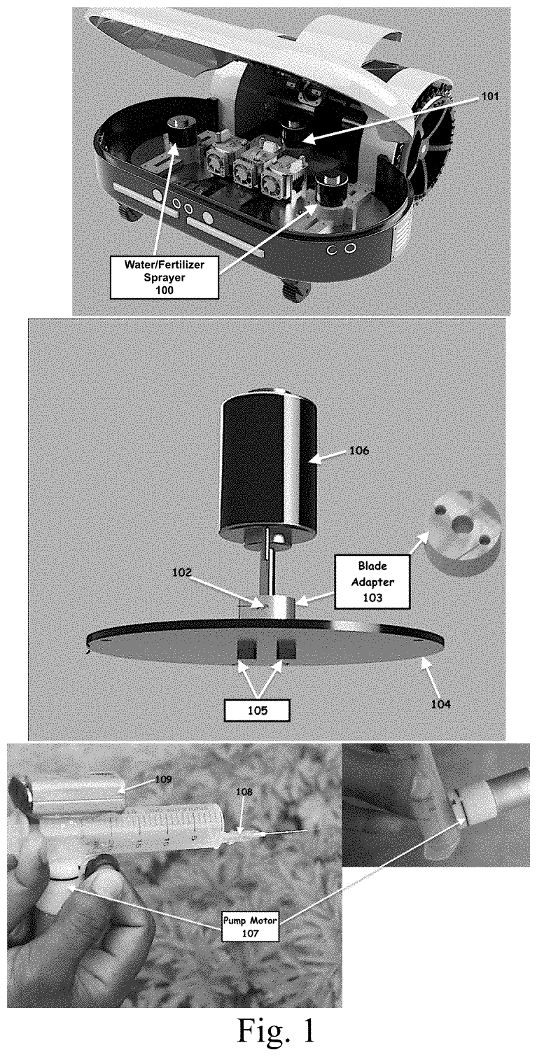

With Reference to FIG. 1 there is provided an illustration of an autonomous robot/gardener comprising; a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns.

In this example, an autonomous robot is arranged to operate on a lawn surface so as to water, cut, fertilize and seed the grass. These actions are commonly known as “watering the lawn or garden”, “mowing the lawn”, “fertilizing the lawn or garden” and “seeding the lawn” respectively, and are often undertaken by gardeners and landscapers to maintain a healthy lawn and garden. The term “gardening services” will be used to encapsulate the different services a landscaper or gardener can perform like watering, cutting, fertilizing and seeding. The term “autonomous gardener” may include any type of watering, fertilizing, cutting and seeding device which can operate autonomously, that is, with minimum user intervention. It is expected that user intervention at some point is required to initialize the gardener or to calibrate the gardener with specific commands, but once these procedures have been undertaken, the robot is largely adapted to operate on its own until further commands are required or error correction is required. Accordingly, autonomous gardeners may also be known as automatic gardening robots, automatic fertilizers, self-driven lawn mowers, self-driven fertilizer, robotic lawn mowers, robotic fertilizers or the like.

In this embodiment as shown in FIG. 1, the autonomous gardener includes a frame or housing which supports the operating components of the gardener. These operating components may include, but not limited to, at least one motor, such as an electric motor, which is arranged to drive the blades of the gardener so as to cut the grass of a lawn to which the gardener is mowing. The at least one motor may also be used to drive the gardener itself via the means of transmission systems such as gearing mechanisms or gear boxes which transmit a driving force to its wheel arrangements, although preferably, as is the case of this embodiment, separate motors are used to drive the gardener along its operating surface with each rear wheel having its own individual motor and gearbox. This is advantageous in that maneuvering the gardener may be implemented by simple control of each of these motors and their motor drivers. It is important to note that the term wheel arrangements may also include driving arrangements that are formed from various different types and combinations of wheels, including tracks (such as in tank tracks), chains, belts (such as in snow belts) or other forms of driving arrangements.

In this embodiment as shown in FIG. 1, the fertilizer and spraying air pump motors 100 are installed and are held down by a clamp that is attached to the gardener body. The air pump motors 100 are then attached to a tank 107 that holds the necessary liquids for the lawn. The spraying mechanism 107 may include, but is not limited to, a tank for the liquid, an air pump or motor to push the liquid through a small nozzle opening and a battery for providing the power to the air pumps.

In this embodiment as shown in FIG. 1, the motor 106-driven blade disk 104 controls the cutting mechanism for the gardener, using a disk 104 to hold and rotate the blade, a blade adapter 103 for attaching the motor 106 to the blade disk 104. The hinges 105 provide a mechanism for holding the spraying mechanism when installed.

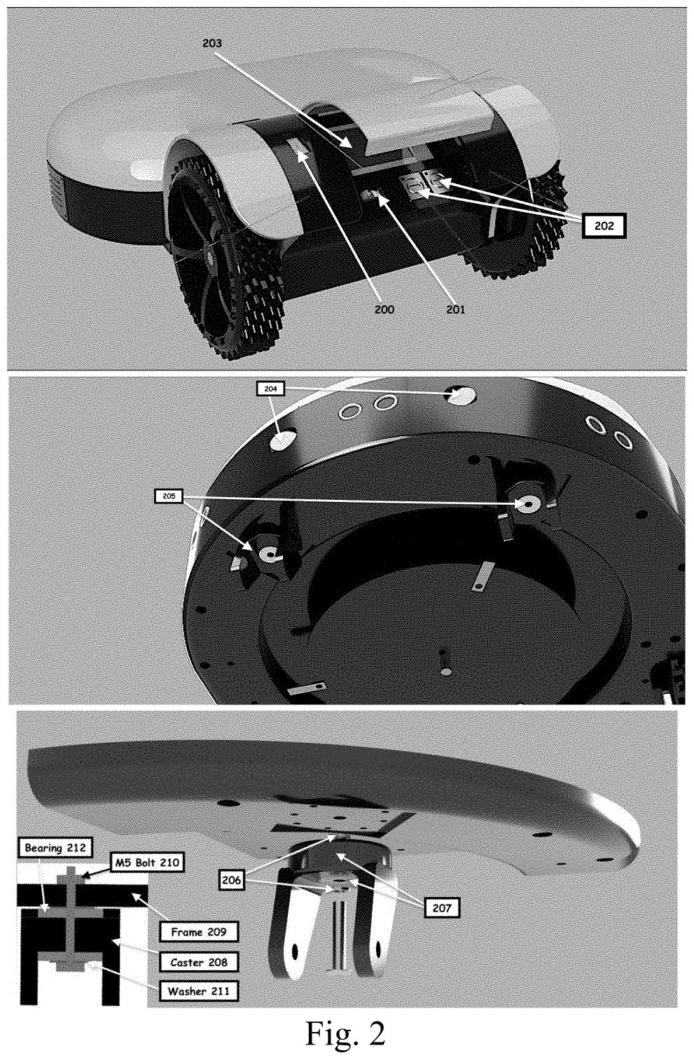

In this embodiment as shown in FIG. 2, the robot includes a user interface for the user to interact with the gardener directly and send it commands. The user interface touch screen 203 allows the user to configure and set up the gardener just as if they were using the mobile software program. Examples of some of the ports used, but not limited to, are the usb ports shown 202 which allow users to import software updates and new mowing patterns that they want to incorporate to the gardener. The on/off switch 201 allows for starting the gardener and stopping it without the need of using the mobile software program. The gardener also attempts to “understand” its environment by including at least one sensor to detect the environment's state. These sensors include, but are not limited to, a rain sensor 200 for detecting rain events. This is especially advantageous as it allows the gardener to know what environmental conditions are suitable for completing the gardener's tasks.

In this embodiment as shown in FIG. 2, an example of the charging mechanism is shown by metal contact plates 204 that are exposed in the front of the gardener, these metal plates provide the connection point for the gardener and the detachable docking module, allowing the detachable docking module to pass electrical charge to the gardener for charging the batteries. These contact points can be placed anywhere that it is suitable for the gardener to receive charge from, for example, these contact points can be placed on the wheel.

In this embodiment as shown in FIG. 2, caster wheels 205 may be used to provide wheels that rotate upon feeling friction forces. This is especially advantageous because it gives the gardener better maneuverability and at least one motor used for steering can be removed from the gardener, lowering the overall cost of manufacturing. An example of the caster mechanism is shown in FIG. 2 by attaching the caster 208 to the gardener frame 209 by using bolts like an M5 bolt 210. Bearings (207, 212) and washers 211 allow for the rotation of the caster when friction is applied.

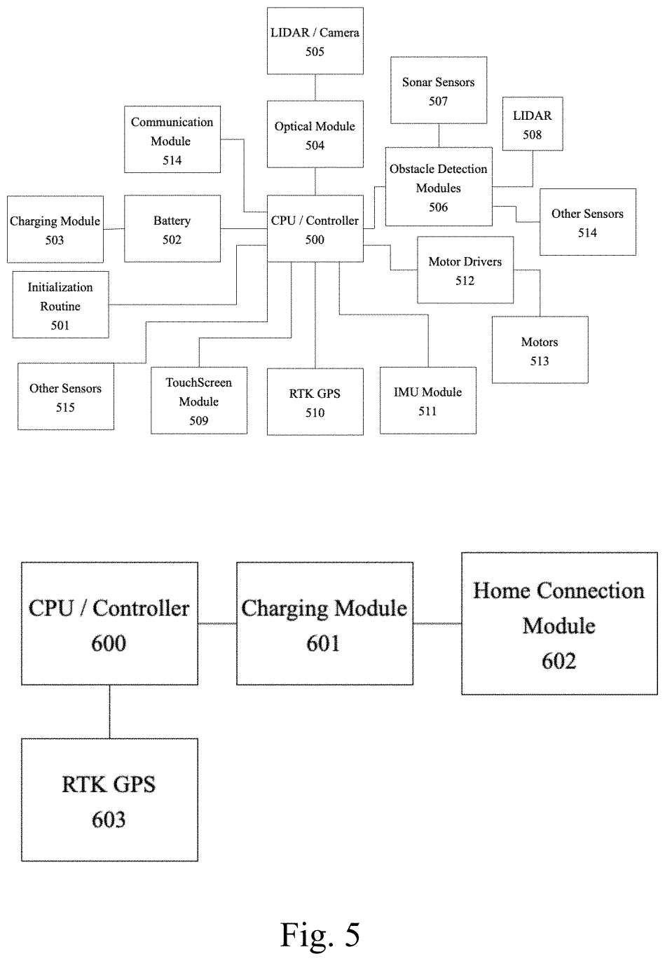

As shown in the embodiment of FIG. 5, the gardener includes a navigation system 510 for locating and navigating the gardener around a working area so the gardener can perform gardening services. The navigation system may include a number of specific navigation modules (504, 505, 506, 507, 508, 510) each arranged to provide individual navigation information obtained for the gardener. In turn, the navigation information obtained or determined by each of these navigation modules are then returned to the navigation system for transmission to a controller 500. Upon processing of the navigation information by the controller 500, the controller 500 may then generate commands which are used to control the movement and operation of the gardener within an operation area.

These navigation modules may include at least the follow:

An inertial measurement unit (IMU) module 511 arranged to measure the force of movement of the gardener by detecting and recording various forces which are subjected on the robot, including the direction of movement, force of movement, magnetic bearing of movement, acceleration and gyroscopic movements. For example, more than one IMUs may be used to improve accuracy, since additional IMUs will assist in eliminating errors over time. An optical surveying module 504 arranged to use an optical means 505 to scan and survey the immediate area around the gardener. An example implementation of this optical surveying module 504 may be the placement of a LIDAR unit 505 on the gardener body so as to scan a surrounding area of the gardener to produce a dynamic map of the immediate spatial environment proximate to the gardener;

A barometric sensor arranged to measure the air pressure surrounding the gardener. Such an arrangement may be advantageous in that the altitude of the gardener can be measured based on the air pressure changes it experiences as the gardener moves along its operation areas or relative to its docking station and thus assist in its localization and navigation. Preferably, the barometric sensor can also be calibrated, either automatically or manually by the use of weather information that is transmitted to the gardener via its communication modules;

A sonic or ultrasonic obstacle detection module arranged to use sound waves to detect if there are any obstacles proximate to the gardener so as to assist the gardener with avoiding these obstacles, or in some examples, to approach one or more objects, whilst avoiding direct contact or collision with the object so as to enhance the operation of the gardener by navigating the gardener to be proximal to certain objects for operation, whilst avoiding a collision with the objects. Example implementations of the sonic obstacle detection module may be by the use of SONAR sensors or ultrasonic sensors which can detect obstacles; and,

Other additional navigation modules (not shown) may also be implemented to communicate with the navigation system so as to provide further input to the navigation system to adjust and control the gardener, including:
GPS sensors which can be used to obtain a GPS coordinate of the gardener. In some examples, the gardener may be implemented to use “RTK GPS” or Real Time Kinematic GPS which includes two GPS modules, one fixed and one in the gardener in addition to advanced GPS information to determine the precise position of the gardener within the mowing area and world;
Compass sensors to obtain a compass bearing of the gardener;
Rain sensors or water sensors to detect if the immediate environment is subject to rain, high levels of moisture or entry of the gardener into a puddle of water and if so, adjust or terminate operation of the gardener;
Edge sensors or cliff sensors to detect if gardener has reached an edge or a cliff whereby any further movement may cause the gardener to experience a fall;
Light sensors to detect light or time of day and adjust operation accordingly, including the switching on of warning lights; and,
Other additional sensors and function modules, such as clock, WiFi, Bluetooth, GSM, RF, DECT, or any other communication protocol modules 514 arranged to receive COMMUNICATION PROTOCOLS external information received via communications connections such as weather reports or remote commands to enhance and control the operation of the gardener.

These navigation modules are each arranged to obtain, detect and determine a set of navigation related information, which are in turn arranged to be processed by a processor on the controller to devise suitable commands to operate the gardener.

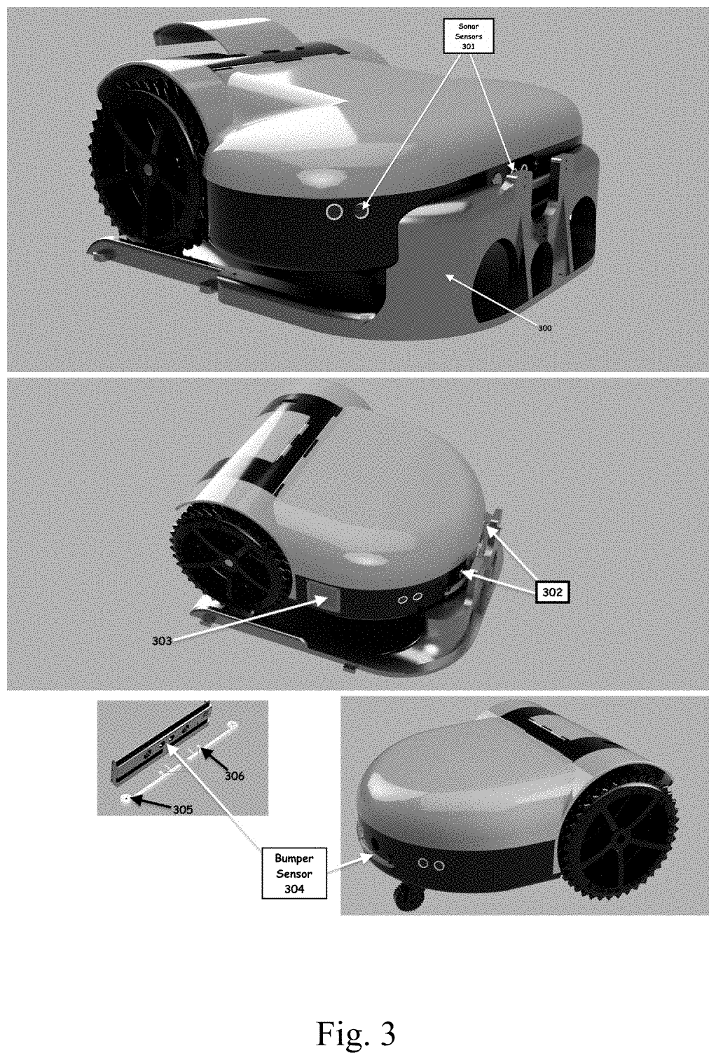

In this embodiment as shown in FIG. 3, the autonomous gardener will operate by moving away from a docking station 300 which will form a start and return point for the gardener. The gardener, when departing the docking station may then use the navigation system to assist with navigating the gardener around a work or operation area by performing the gardening services on the lawn in the operating area, and then proceeding to navigate its way back to the docking station. On returning to the docking station, the gardener will use metal contact points 302 to signal to the controller 500 when it has fully reached the docking station and it is ready for charging the gardener's batteries 502. The gardener includes a bumper sensor 304, which attaches to the gardener using a snapping mechanism (305-306), for detecting when the gardener makes contact with other objects or the docking station. This is advantageous as it allows the gardener to physically “feel” the docking station. Sonar sensors 301 attached to the front and side of the gardener allow us to object detect and detect the side walls (walls not shown here) of the docking station.

Also illustrated, is the air vent or vents 303 used to push hot air out of the inside of the gardener body and onto the environment.

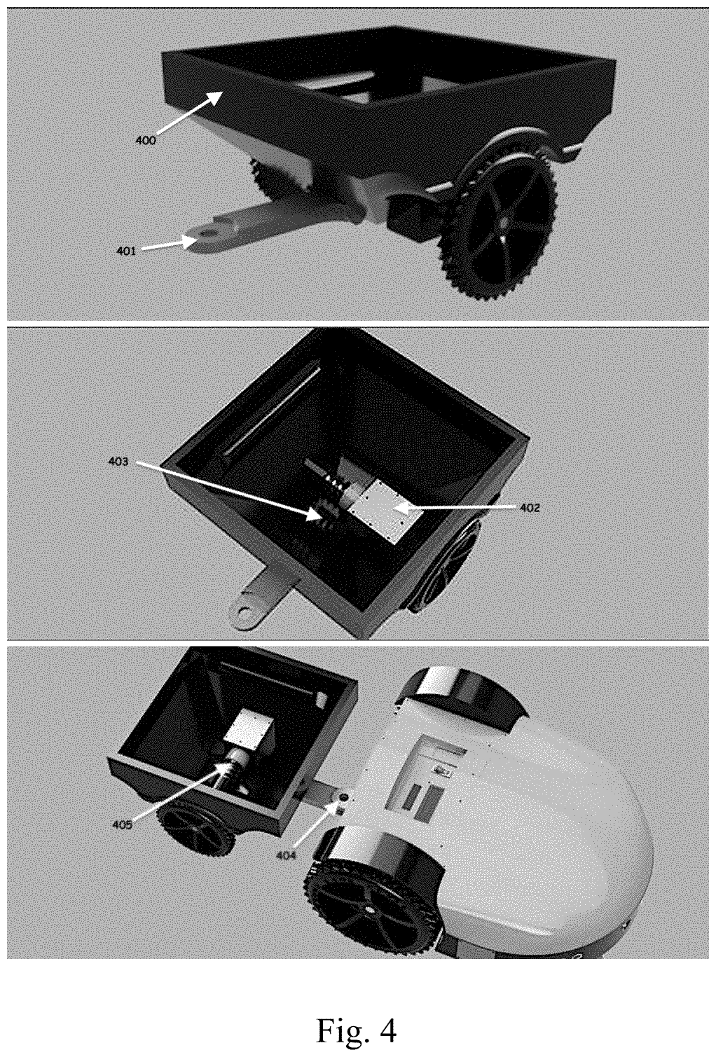

In this embodiment as shown in FIG. 4, the autonomous gardener can operate a tank by pulling the tank using a tow hitch mechanism 404 as it navigates the operating areas. The tank 400 provides its own hitch 401 that is to be received by the gardener 404. The tank has the option of including a seeding mechanism by attaching the mechanism to the tank 402. The tank is filled with seeds and the roller 405 rotates at a consistent speed related to the rotation of the tank wheels. The roller 405 includes a few gear teeth used to consistently spread out and deliver seeds to the ground through a hole 403 in the tank.

With reference to FIG. 5, there is provided a block diagram of the autonomous gardener which illustrates the components of the autonomous gardener (500-514) and the detachable docking module (600-603). In this embodiment, the gardener includes a controller/processor 500 which may be implemented as a computing device, or as one or more control boards, with each having one or more processors arranged to receive and analyse the information received and to provide instructions to the gardener in order to operate the gardener. Preferably, the controller/processor 500 is implemented with a main printed circuit board assembly (PCBA) arranged to have at least one processor on the PCBA and to operate seamlessly with an additional computing module. Several of the sensor PCBAs may also have their own individual Microcontroller units (MCU).

The controller/processors 500 is arranged to receive navigation information from the navigation system 510 of the gardener and in turn, upon the receipt of this navigation information, will process the navigation information with existing information already accessible by the controller 500 to generate various commands to each of the gardener operating components, including the motor drivers 512 arranged to drive the gardener and/or the blade and spraying motors 513.

As shown in FIG. 5, the navigation system includes the optical surveying module 504 (such as an LIDAR unit 505), the IMU unit 511, the sonic obstacle detection module 506, which may include Sonar sensors 507 or LIDAR 508 although other sound or light wave based obstacle detections methods 514 are possible. Each of these modules are arranged to provide a specific function and return individual navigation information either detected, calculated, gathered or surveyed, as in the case of the LIDAR or camera unit 505 which is arranged to generate a virtual map representative of the obstacles or placement of specific objections proximate to the gardener.

As illustrated in this embodiment, the controller is also arranged to control the motor drivers 512 and motors 513 to drive the gardener along a work surface within a work area. Preferably, as is the case in this embodiment, the gardener is driven by having a motor placed adjacent to each of the rear wheels with each motor being arranged to drive each rear wheel.

In turn, the controller 500 can direct electric current from a power source, such as a battery 502, to the motors drivers 512 so as to perform a controlled operation of one or both motors 513. This can allow for forward, reverse and turning actions of the gardener by turning one or more wheels at different speeds or directions. The battery 502 includes a charging module 503 for providing safe balance charging to the battery's cells and preventing over or dis-charging.

The controller 500 can also command the blade and spray motors 512 to operate so as to operate the blades to cut the grass and the sprayer to water or fertilize the grass of a work surface. To perform these functions, the controller 500 will execute a control routine or process which determines the conditions for and when the gardener is to be operated. These commands at least include instructions to command the direction of travel of the gardener and the operation of the blades and sprayers. Other commands are also possible, including the command of the gardener to travel to a particular location within a work area, or to return to a specific location, such as a docking station as well as specific commands such as the operating speed of the blade motor or the height of the blade so as to determine the level of grass that is cut or determining the areas to spray at.

The controller 500 may also be pre-programmed with an initialization routine 501 wherein the gardener's working area and work surfaces are initially identified. This process may assist in identifying the boundaries of a working area and the categorization that certain surfaces within the boundaries should be avoided (no travel zones) or should not have the blade or sprayer motor activated. Once these working areas are identified, the gardener can then be controlled by the controller to navigate to a starting point from the docking station, wherein the gardener can proceed to spray and cut the grass from the starting point. The initialization routine 501 includes, but not limited to, calibrating different navigation sensors like RTK/GPS, IMUs or magnetometers, setting a schedule for operation, adding the boundaries to operate and not operate in, and setting target areas for health detection.

As illustrated in FIG. 5, the block diagram for the detachable docking module is illustrated (600-603) and shows some of the components of the module, but the docking module can include more components. The docking module controller 600 receives navigational information (603) that is sent to the autonomous gardener. The charging module 601 expects to physically connect to the gardener's charging module 503 to provide electrical charge from the home connection module 602 to the gardener.

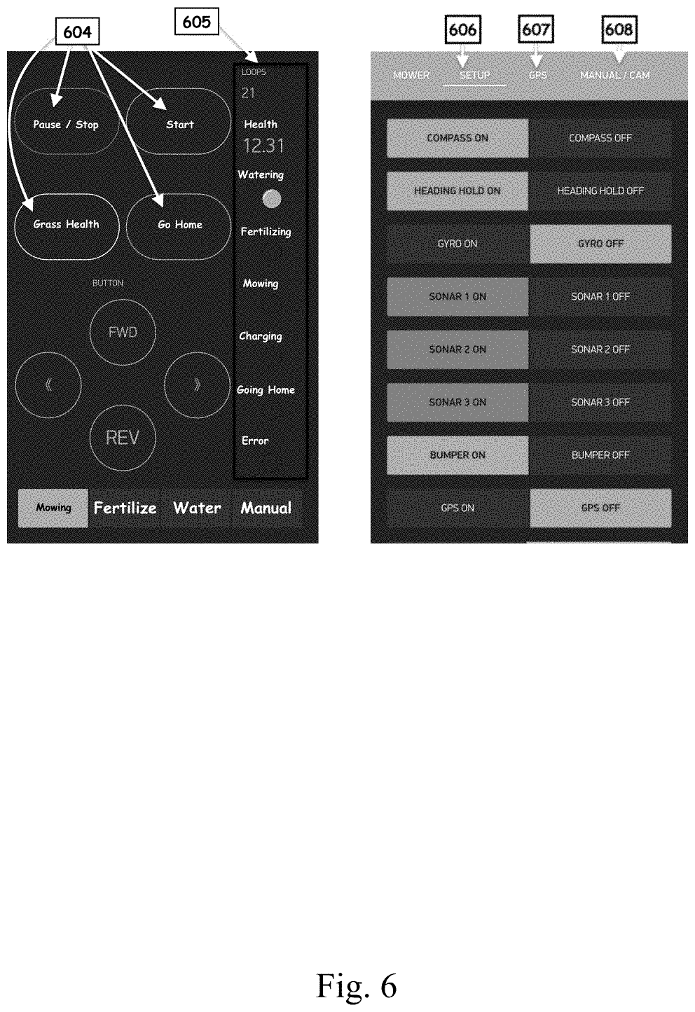

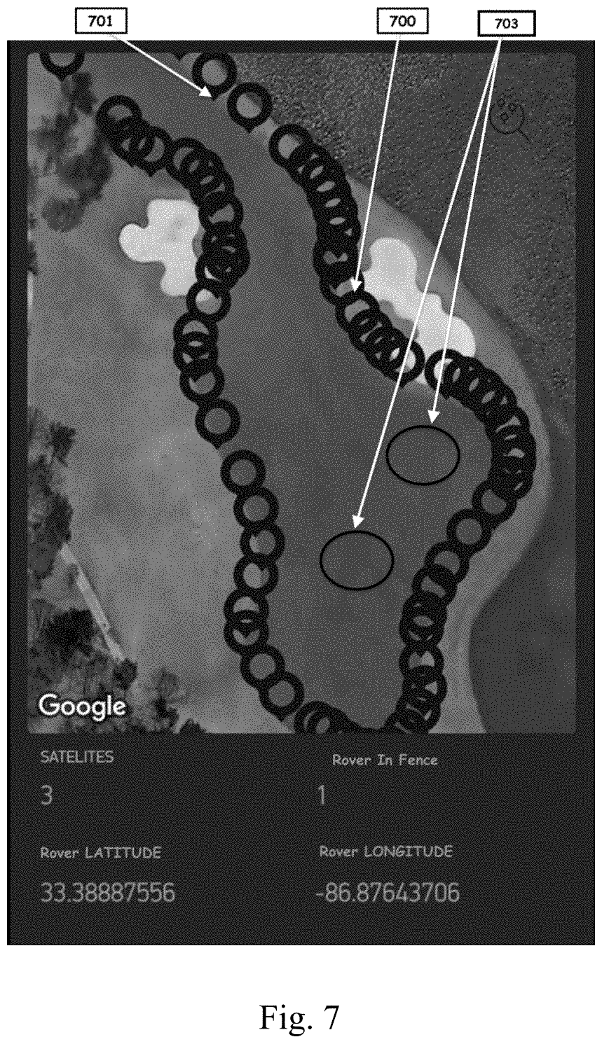

As illustrated in FIG. 6, the software program is used to configure and change the state of operation of the gardener. Including, but not limited to:
A status bar 605 for quickly checking different gardener stats like Health, Watering, Fertilizing, distance travelled, gardener state, errors;
Commands in the form of buttons 604 for starting, stopping, checking health, going home and remote controlling the gardener;
A detailed sensor status page 606 for, but not limited to, checking status on different sensors and sending commands to change operation of the sensors. Users can quickly see if sensors are on or off and can send commands to turn certain sensors on or off;
A GPS page 607 for setting boundaries, target areas and mowing patterns. Referenced more in FIG. 7;
If a camera is included, the user can see what the gardener visualizes using the camera attached to the gardener through the Manual/CAM tab 608. If no camera is included or the camera is not operating, the Manual/CAM tab 608 shows the user the best virtual representation of the gardener's surroundings.

As illustrated in FIG. 7, an example of how a user can set the boundaries of the working area by using the map provided by the software or mobile program is shown. Users place circles 700 around the perimeter of the working areas and non-working areas and designate each area respectively. The circles placed by the user can be modified and moved using the small triangle 701 attached to the circle. Users can use circles 703 to set specific target areas that they want the gardener to focus on either for spraying, cutting, seeding or checking the health status of the area.

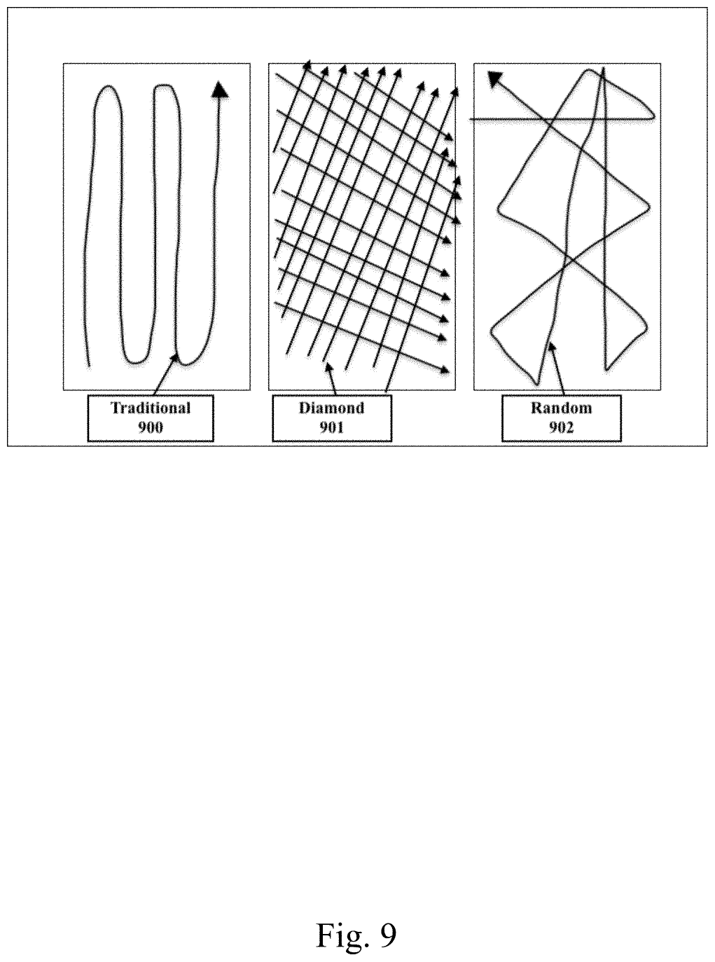

As illustrated in FIG. 9, a few examples of different mowing patterns that the autonomous gardener can provide on a lawn are shown. A traditional pattern 900, is defined as a mowing pattern where the cutting direction goes back and forth from end to end of the lawn. A diamond pattern 901, is defined as a mowing pattern where the cutting directions overlap each other at a set angle, preferably at a 60 to 120 degree angle. A random pattern 902, is defined as a mowing pattern where the cutting direction is random and based on the random movements of the gardener over the working area.

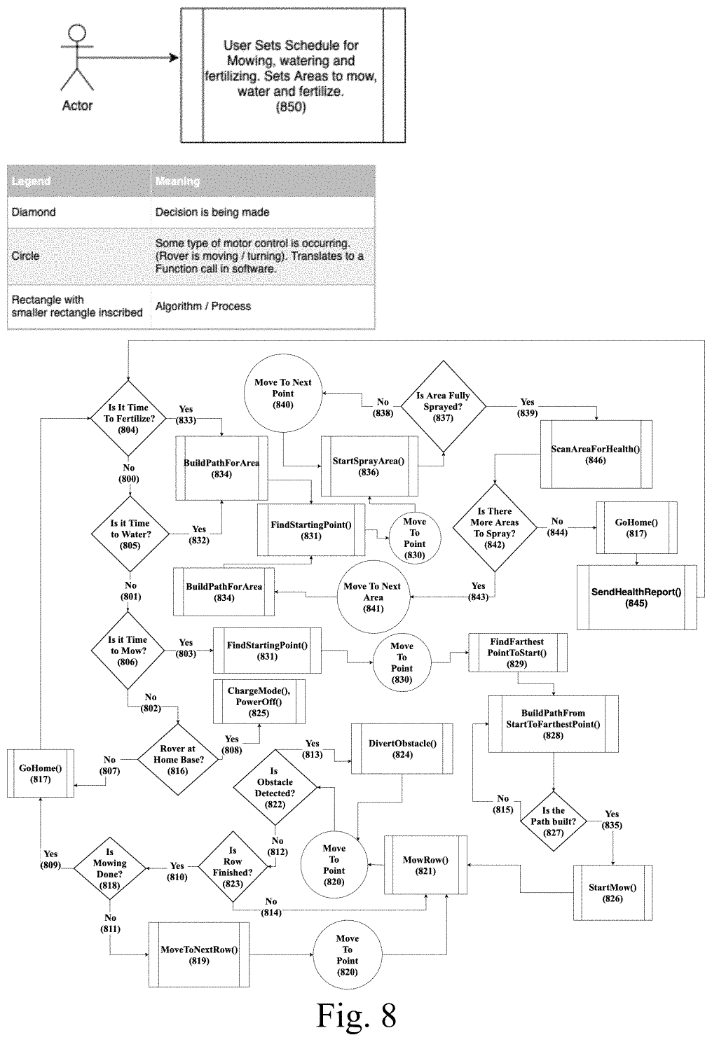

As illustrated in FIG. 8, an example of the process used by the autonomous gardener to automate the watering, fertilizing and cutting of the lawn is shown. The user will set the initial configuration for the gardener 850, including, but not limited to, calibrating, setting boundary and target areas. The gardener will either be in a state of fertilizing (804 & 833), watering (805 & 832), mowing (806 & 803) or going home 817. Fertilizing 804 is activated 833 and deactivated 800 on a schedule or manual basis. Watering 805 is activated 832 and deactivated 801 on a schedule or manual basis. Once the fertilizing or watering is activated, the controller 500 is tasked with building an optimal path 834 for the first area that the gardener will spray in. The controller then finds the starting point 831 of the optimal path built 834, the starting point 831 is the first point that the gardener should reach when leaving the docking station or leaving a completed area. After finding the starting point, the controller then sends the necessary power to the motors for moving to the point 830. Once the gardener reaches the first point, the gardener can start the spraying process 836. After some allotted time or a similar means of detecting when to stop spraying, the controller decides whether the area has been fully sprayed or not 837 by using the navigation system to figure out if the gardener has been at all points within one working area. If the controller detects that the area is not fully sprayed 838, then the gardener will move to the next point 840 within the same area and start spraying that point 836. The controller will loop through these actions (836, 837, 838 & 840), until it determines the area is fully sprayed 839 by using the navigation system. The controller will then be tasked with scanning the fully sprayed area for grass and plant health 846 by using LIDAR and other sensors to measure light intensity and other measurable units for a plant that may indicate its health status. We will continue this sequential process until the gardener determines that all areas have been sprayed (842 & 844) by using navigation information to determine if the gardener has visited all working areas. This process includes detecting objects with the help of four ultrasonic sensors or other similar sensors like LIDAR. Once an object is detected, we use the ultrasonic sensor or other sensors to move around the object and go to the next point. After the spraying operation is done 844, the controller is tasked with moving the gardener back to its docking station 817 for charging and resting until the next operation. Once the gardener reaches the docking station, the controller must assemble all the health data into a consolidated report 845 that is sent to the user through some type of communication protocol onto the software or mobile program.

After the report is sent, the gardener stays in the docking station until it is time for another operation to take place.

Mowing 806 is activated 803 and deactivated 802 on a schedule or manual basis. Once the mowing is activated 803, using the navigation data of the working areas, the gardener will find the starting point 831 for the first area and move to its starting position 830. The controller then finds the farthest point from the current starting point 829, wherein the farthest point is defined as a point within the working area that has the greatest distance possible between two points in the same working area. After the farthest point is calculated, the controller builds a plan for the mowing path, incorporating the mowing pattern (900, 901, 902) given by the user, between the start and farthest point 828 by finding sequential GPS coordinates between the points. The controller will continue to try and build the path (827 & 815) for some allotted time or attempts until an error message is eventually sent out. Once the path is built (827 & 835), the gardener will then go through its process of cutting the grass 826 by mowing each row 821 of an area, wherein a row is defined as a path created by the controller that has a start and farthest point from start (end point) and sequential points in between the start and end point. This process includes detecting objects with the help of sensors 822. Once an object is detected 813, we use the sensors to move around the object 824 and go to the next point to cut 820. The gardener will then check to see if it has reached the current point in the built mowing path plan by using navigation data. If the current point has been reached then the gardener will continue to the next point. Otherwise, the gardener will try reaching the current point for an allotted amount of time before moving on to the next point. The gardener checks if the row is finished mowing 823 by checking if the final ending point has been reached by the gardener. If the endpoint is not reached 814, the gardener has more points within the row to cut 821. Once the endpoint is reached 810, we check if mowing is done 818 by using the navigation system to check if the gardener has reached the end point of all rows within a working area. If all rows within a working area are not done 811, the controller will move the gardener to the next row 819 and onto the first point within the row 820 to start mowing 821. If mowing is determined to be done (818 & 809), by using the navigation system to check if all rows have been finished, the controller will move the gardener back to its docking station 817 for charging and resting until the next task. Throughout the entire process, the gardener checks for rain or for a low battery. If either one of these cases is true, the controller will save its current state in the built mowing path plan or spraying plan and return the gardener home for charging. Once the charging is done, it will finish its mowing or spraying at the last saved path plan point. This entire process, from spraying to mowing, will happen on a schedule or manual basis. When the gardener is not watering, fertilizing or mowing 802, the controller will use navigation data to decide if the gardener is home or not 816. If not home 807, the controller will take the gardener home 817. If home 808, the controller will power off 825 and put the gardener in charge mode 825 as it has finished its gardening tasks.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An autonomous robot/gardener comprising:
a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns;
wherein the robot body further includes an automatic gardening system for watering, fertilizing, and mowing the garden or lawn.

2. The autonomous gardener of claim 1, wherein the robot body further includes at least one tank and sprayer arranged to assist the controller in watering or fertilizing the lawn.

3. The autonomous gardener of claim 2, wherein the automating gardener includes a method/process for automating garden tasks and includes one or more sensors to detect the different states (watering, fertilizing, mowing, going home, etc.) of the gardener while executing the method.

4. The autonomous gardener of claim 3, further includes a method/process for creating lawn patterns by using sensors and motors to control and adjust the height and angle of the cutting blade.

5. The autonomous gardener of claim 4, further includes a method/process for checking plant health using at least one or more sensors to detect different plant diseases and discolorations.

6. The autonomous gardener of claim 1, further includes a detachable tank arranged to hitch onto the gardener and be pulled during seeding.

7. The autonomous gardener of claim 1, further includes a detachable docking module arranged to receive the robot body; wherein the robot body includes at least one sensor arranged to assist the controller in charging the robot's batteries and terminating movement of the robot.

8. An autonomous robot/gardener comprising:
a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body further includes an angle and height adjustment system arranged to assist the controller in restricting operation of the cutting blade to computed angles and heights for the lawn pattern system.

9. The autonomous gardener of claim 8, wherein the lawn pattern system includes a method/process for computing the heights and angles of different lawn areas necessary for creating the user defined lawn pattern.

10. The autonomous gardener of claim 9, further includes a roller placed parallel to the ground and attached to the bottom of the gardener body used for building lawn patterns.

11. The autonomous gardener of claim 10, further includes a method/process for mowing the lawn using only a roller, as the tool for changing grass blade angles, when creating mow patterns.

12. An autonomous robot/gardener comprising:
a robot body having at least one motor arranged to propel the robot body via a wheel arrangement and drive a cutting blade or trimmer line, wherein the robot body also has predefined areas for including at least one more motor to drive a sprayer, trimmer or edging blade. Wherein, the robot body includes one or more navigation modules arranged to assist a controller to control navigation of the robot, generate a virtual representation of surroundings and operating areas and generate lawn mowing patterns; wherein the robot body further includes a plant health detection system arranged to detect plant or lawn health.

13. The autonomous gardener of claim 12, wherein the plant health detection system includes one or more sensors arranged to measure and scan the lawn or plants of a garden for detecting plant anomalies.

14. The autonomous gardener of claim 13, further includes a method/process for targeting an unhealthy area and providing more gardening services to the unhealthy area.

15. The autonomous gardener of claim 14, wherein the method includes a software program to view the unhealthy areas on a map.

16. The autonomous gardener of claim 13, further includes a method/process for generating a health report from sensor data received by the controller.

17. The autonomous gardener of claim 15, wherein the method includes a software program to view the health reports that are sent by the gardener's controller.
